(19) United States
(12) Patent Application Publication
(10) Pub. No.: US 2025/0209335 A1
(43) Pub. Date: Jun. 26, 2025

(54) METHOD AND SYSTEM FOR ENHANCING RECOGNITION MODEL ACCURACY ACROSS SOURCE AND TARGET DOMAINS

(71) Applicant: oToBrite Electronics Inc., Hsinchu (TW)

(72) Inventor: Chia-Chun Chung, Hsinchu City (TW)

(21) Appl. No.: 18/395,689

(22) Filed: Dec. 25, 2023

(51) Int. Cl. G06N 3/09; G06F 17/14

(52) U.S. Cl. CPC G06N 3/09; G06F 17/142

(57) ABSTRACT

The present invention provides a method for enhancing recognition model accuracy across source and target domains and a system thereof. The method includes the steps of: extracting amplitude and phase components from a source domain dataset and a target domain dataset, respectively; separating high-frequency components from the amplitude components of the target domain dataset and low-frequency components from the amplitude components of the source domain dataset; creating an augmented amplitude in a frequency domain by incorporating the high-frequency components separated from the target domain dataset into the low-frequency components separated from the source domain dataset; generating an augmented synthetic dataset based on the augmented amplitude and the phase components of the source domain dataset; and training the recognition model with the augmented synthetic dataset.

### FIELD OF THE INVENTION

The present invention relates to a method and a system for enhancing recognition model accuracy. More particularly, the present invention relates to a method and a system for enhancing recognition model accuracy across source and target domains.

### BACKGROUND OF THE INVENTION

Face recognition technologies have become increasingly vital across various domains, including security and identification systems. Nonetheless, existing systems encounter notable challenges in achieving high accuracy, particularly when confronted with variations in spatial and spectral characteristics. In recent times, deploying a robust face recognition product has become more accessible due to decades of advancement in face recognition techniques. Cutting-edge methods can effectively handle profile image verification as well as perform admirably in processing in-the-wild images. However, the rise of privacy concerns has been swift, as mainstream research heavily relies on vast web-crawled datasets, which raises issues of privacy invasion. The community has sought to navigate this predicament by training face recognition models using synthetic data, but this endeavor has encountered substantial domain gap challenges, necessitating access to real images and identity labels for model fine-tuning.

With the evolution of deep learning techniques, modern face recognition methods have made significant performance strides, achieving over 99.5% validation accuracy on the Labeled Faces in the Wild (LFW) dataset and a TAR of 97.70% at FAR=1e-4 on the IJB-C dataset. Beyond these successes, researchers have expanded the capabilities of modern face recognition techniques to special applications, such as recognizing faces with masks and under near-infrared lighting conditions. However, many of these methods rely on web-crawled datasets like MS1M, CASIA-Webface, and WebFace260M, and various challenges persist:
Privacy Issue: Acquiring consent from all individuals in large datasets, like WebFace260M with four million people and over 260 million face images, is an exceedingly complex task.
Long-Tailed Distribution: Datasets exhibit significant variations in the number of images, poses, and expressions per person.
Image Quality: Maintaining consistent image quality throughout large datasets is challenging.
Noisy Labels: Web-crawled image datasets may have issues with noisy labels, as social networks often automatically label face images, leading to occasional mislabeling.
Lack of Attribute Annotations: Comprehensive annotations for facial attributes, such as pose, age, expression, and lighting, are typically unavailable.

The primary challenge, privacy concerns, revolves around the use of recognizable information. While attempts have been made to mitigate privacy concerns by adding unrecognizable noise or random-region masks to face images, there remains a risk of real and identifiable images being exposed. To resolve privacy concerns once and for all, the use of synthetic data for training face recognition models emerges as a viable solution. Thanks to advancements in generative models and computer graphics, realistic images can now be generated using computational resources. However, the domain gap remains a significant obstacle, and previous efforts have often resorted to using real images and labels to bridge this gap, which compromises privacy-preserving efforts.

Hence, a solution capable of addressing the aforementioned challenges and simultaneously enhancing the accuracy of face recognition networks is desperately desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In order to improve the accuracy of face recognition networks and address the challenges mentioned earlier, the present invention introduces a Spatial Augmentation and Spectrum Mixup (SASMU) system. This system combines spatial data augmentation (SA) and spectrum mixup (SMU) techniques using synthetic datasets, operating in both the spatial and frequency domains. Additionally, it includes methods for dataset preparation and spectrum mixup to control, render, and align synthetic faces. The proposed spectrum mixup method is designed to mitigate the gap between synthetic and real domains and is introduced following an analysis of dataset statistics. Specifically speaking, the present invention analyzes the impact and potential of spatial data augmentation (SA) by providing analytical results for various options, including grayscale and perspective operations, and applies spectrum mixup (SMU) to reduce the gap between synthetic and real domains without the need for real face images during training, and achieves state-of-the-art face recognition performance without using any personally identifiable information.

In one aspect, the present invention provides a method for enhancing recognition model accuracy across source and target domains which includes the steps of: extracting amplitude and phase components from a source domain dataset and a target domain dataset, respectively; separating high-frequency components from the amplitude components of the target domain dataset and low-frequency components from the amplitude components of the source domain dataset; creating an augmented amplitude in a frequency domain by incorporating the high-frequency components separated from the target domain dataset into the low-frequency components separated from the source domain dataset; generating an augmented synthetic dataset based on the augmented amplitude and the phase components of the source domain dataset; and training the recognition model with the augmented synthetic dataset.

Preferably, the amplitude and phase components are extracted by applying Fourier Transform to the source domain dataset and the target domain dataset.

Preferably, frequency components of both the source domain dataset and the target domain dataset are acquired through the application of a 2D discrete Fourier Transform.

Preferably, the high-frequency components are separated by a high-pass Gaussian filter and the low-frequency components are separated by a low-pass Gaussian filter.

Preferably, the augmented amplitude is created by combining the low-frequency components of the source domain dataset, which have been modified using a Gaussian mask, and the high-frequency components of the target domain dataset, which have undergone a complementary operation (1-Gaussian) that subtracts each value in the Gaussian mask from 1.

Preferably, the high-frequency components of the target domain dataset and the low-frequency components of the source domain dataset are incorporated to minimize domain gap between the source domain dataset and the target domain dataset by using a Gaussian-based soft-assignment map.

Preferably, the phase components of the target domain dataset, which contain data requiring privacy preservation, are filtered out during the generation of the augmented synthetic dataset.

Preferably, the augmented synthetic dataset is generated by applying an inverse discrete Fourier transform (DFT) or an inverse fast Fourier transform (FFT) to the augmented amplitude and the phase components of the source domain dataset.

Preferably, the augmented synthetic dataset contains labels encoded in the phase components of the source domain dataset.

Preferably, the augmented synthetic dataset undergoes desensitization before being supplied to the recognition model.

In another aspect, the present invention provides a system for enhancing recognition model accuracy across source and target domains which includes: a database, stored with a source domain dataset and a target domain dataset; a processing unit, connected to the database, for extracting amplitude and phase components from the source domain dataset and the target domain dataset, respectively, and for separating high-frequency components from the amplitude components of the target domain dataset and low-frequency components from the amplitude components of the source domain dataset; an integration unit, connected to the processing unit, for creating an augmented amplitude in a frequency domain by incorporating the high-frequency components separated from the target domain dataset into the low-frequency components separated from the source domain dataset; a dataset generating unit, connected to the integration unit, for generating an augmented synthetic dataset based on the augmented amplitude and the phase components of the source domain dataset; and a recognition model, connected to the dataset generating unit, trained with the augmented synthetic dataset provided by the dataset generating unit.

Preferably, the amplitude and phase components are extracted by applying Fourier Transform to the source domain dataset and the target domain dataset.

Preferably, frequency components of both the source domain dataset and the target domain dataset are acquired through the application of a 2D discrete Fourier Transform.

Preferably, the high-frequency components are separated by a high-pass Gaussian filter and the low-frequency components are separated by a low-pass Gaussian filter.

Preferably, the augmented amplitude is created by combining the low-frequency components of the source domain dataset, which have been modified using a Gaussian mask, and the high-frequency components of the target domain dataset, which have undergone a complementary operation (1-Gaussian) that subtracts each value in the Gaussian mask from 1.

Preferably, the high-frequency components of the target domain dataset and the low-frequency components of the source domain dataset are incorporated to minimize domain gap between the source domain dataset and the target domain dataset by using a Gaussian-based soft-assignment map.

Preferably, the phase components of the target domain dataset, which contain data requiring privacy preservation, are filtered out during the generation of the augmented synthetic dataset.

Preferably, the augmented synthetic dataset is generated by applying an inverse discrete Fourier transform (DFT) or an inverse fast Fourier transform (FFT) to the augmented amplitude and the phase components of the source domain dataset.

Preferably, the augmented synthetic dataset contains labels encoded in the phase components of the source domain dataset.

Preferably, the augmented synthetic dataset undergoes desensitization before being supplied to the recognition model.

### BRIEF DESCRIPTION OF THE DRAWINGS

FIG. 1 is a block diagram illustrating major components of a system for enhancing recognition model accuracy across source and target domains according to an embodiment of the present invention.

FIG. 2 is a flowchart illustrating a method for enhancing recognition model accuracy across source and target domains according to an embodiment of the present invention.

FIG. 3 provides a conceptual overview demonstrating how an augmented synthetic dataset is generated according to an embodiment of the present invention.

FIGS. 4A˜4D offer conceptual overviews illustrating various methods for generating an augmented synthetic dataset, as compared to the method illustrated in FIG. 3.

FIG. 5 depict example comparison results of the performance/average accuracy using various methods illustrated in FIG. 3 and FIGS. 4A˜4D.

FIG. 6 is the visualization results using various methods illustrated in FIG. 3 and FIGS. 4A˜4D and PSNR values indicating the image quality and similarity between original synthetic image and the augmented synthetic dataset.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

Recognition models are widely used for various applications, but their performance can be hindered when dealing with source and target domains that exhibit domain gaps. The present invention addresses this issue by introducing a novel method and system for enhancing recognition model accuracy across these domains. The present invention provides a system and a method for enhancing accuracy of a recognition model across source and target domains. Specifically, the present invention relates to the field of machine learning and recognition models, particularly for improving accuracy across source and target domains by manipulating frequency domain components. The recognition model is trained on synthetic data within a source domain and applied to real images within a target domain. While the present embodiment focuses on face recognition, it's important to note that the invention's applicability extends beyond this use case and can be employed in various domains, including Advanced Driver Assistance Systems (ADAS) and diverse camera applications.

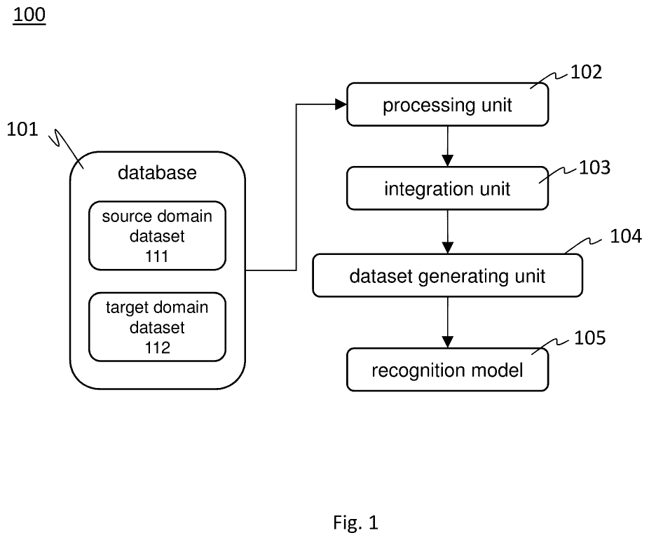

In FIG. 1, we present a schematic depiction of the primary components within a system denoted as 100, devised to enhance the precision of a recognition model across both source and target domains, as per an embodiment of the present invention. As illustrated, the system 100 includes the following integral elements: a database 101, a processing unit 102, an integration unit 103, a dataset generating unit 104, and a recognition model 105. The database 101 is stored with a source domain dataset 111 and a target domain dataset 112. The processing unit 102 is connected to the database 101, facilitating the extraction of amplitude and phase components from the source domain dataset 111 and the target domain dataset 112, respectively. Furthermore, the processing unit 102 is responsible for segregating the high-frequency components from the amplitude components of the target domain dataset 112 and the low-frequency components from the amplitude components of the source domain dataset 111. The integration unit 103 is interconnected with the processing unit 102 and is tasked with synthesizing an augmented amplitude in a frequency domain. This is achieved by combining the high-frequency components extracted from the target domain dataset 112 with the low-frequency components extracted from the source domain dataset 111. The dataset generating unit 104 is linked to the integration unit 103 and is responsible for generating an augmented synthetic dataset based on the augmented amplitude and the phase components derived from the source domain dataset 111. The recognition model 105 is connected to the dataset generating unit 104 and undergoes training with the augmented synthetic dataset provided by the dataset generating unit 104.

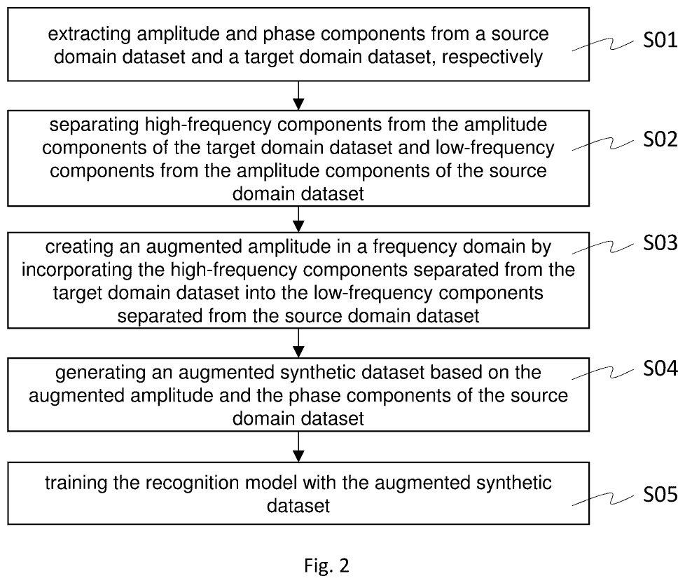

For a better understanding of the present invention, please refer to FIG. 2 which is a flowchart illustrating a method for enhancing recognition model accuracy across source and target domains according to an embodiment of the present invention. The method described in this invention can be summarized as follows: step S01 involves extracting amplitude and phase components from a source domain dataset 111 and a target domain dataset 112, respectively. In step S02, high-frequency components are separated from the amplitude components of the target domain dataset 112, while low-frequency components are separated from the amplitude components of the source domain dataset 111. Step S03 entails creating an augmented amplitude in the frequency domain by combining the high-frequency components separated from the target domain dataset 112 with the low-frequency components separated from the source domain dataset 111. Step S04 involves generating an augmented synthetic dataset based on the augmented amplitude, created in step S03, and the phase components of the source domain dataset 111. Finally, in step S05, the recognition model 105 is trained using the augmented synthetic dataset generated in step S04.

Regarding frequency component extraction, the amplitude and phase components within the source domain dataset 111 and the target domain dataset 112 are extracted by applying Fourier Transform. In particular, the frequency components of both datasets are acquired through the application of a 2D discrete Fourier Transform. With respect to high-frequency and low-frequency separation, the high-frequency components are separated from the amplitude components of the target domain dataset 112 using a high-pass Gaussian filter, while the low-frequency components are separated from the amplitude components of the source domain dataset 111 using a low-pass Gaussian filter.

As for augmented amplitude creation, the augmented amplitude is created by combining the low-frequency components of the source domain dataset 111, which have been modified using a Gaussian mask, and the high-frequency components of the target domain dataset 112, which have undergone a complementary operation (1-Gaussian) that subtracts each value in the Gaussian mask from 1. This combination serves to minimize the domain gap between the source domain dataset 111 and the target domain dataset 112 by employing a Gaussian-based soft-assignment map. Concerning privacy preservation, the phase components of the target domain dataset 112, which may contain data requiring privacy preservation, are filtered out during the generation of the augmented synthetic dataset.

Touching on augmented synthetic dataset generation, the augmented synthetic dataset is generated by applying an inverse discrete Fourier transform (DFT) or an inverse fast Fourier transform (FFT) to the augmented amplitude and the phase components of the source domain dataset 111. Notably, the augmented synthetic dataset contains labels encoded in the phase components of the source domain dataset 111. In consideration of desensitization, the augmented synthetic dataset undergoes desensitization to protect sensitive information before being supplied to the recognition model 105.

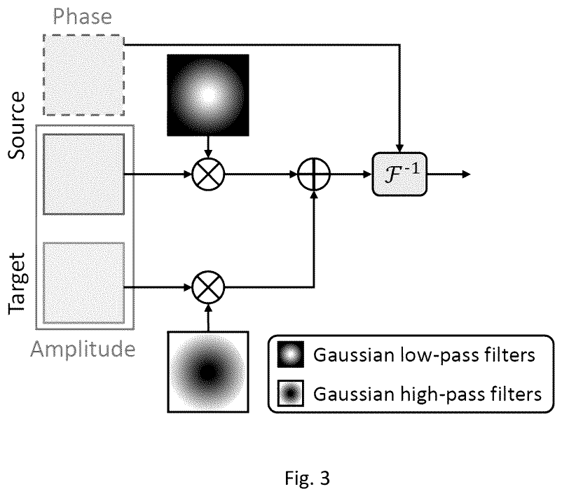

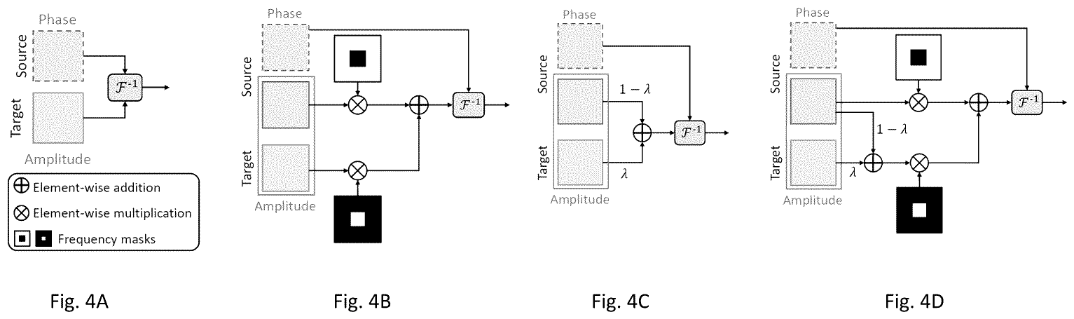

The primary goal of the present invention is to create a face recognition model that prioritizes privacy by utilizing a synthetic dataset for training. The invention introduces a groundbreaking data augmentation technique called Spectrum Mixup (SMU) to address the domain gap between real and synthetic datasets, as depicted in FIG. 3. Unlike other frequency domain mixup strategies, as depicted in FIGS. 4A˜4D, which employ weighted sum operations or hard-assignment masks, the present invention integrates the amplitude components of synthetic and real data through a Gaussian-based soft-assignment map, and enhances high-frequency information, as illustrated in FIG. 3.

In this particular embodiment, several underlying hypotheses may be selectively made: 1) semantic content, specifically identity information, is predominantly encoded in the phase components; 2) infusing amplitude information from real data into synthetic data improves alignment with the real dataset distribution; and 3) boosting high-frequency information proves more effective than low-frequency information. This is due to deep neural networks prioritizing the fitting of certain frequencies, typically progressing from low to high. Consequently, synthetic data inherently capture realistic low-frequency information but lack intricate high-frequency details.

For a more comprehensive grasp of the present invention, below is an exemplary formula used to obtain the frequency components of an image x∈R^{M×N} by use of the

$$ℱ ( x ) ( u , v ) = {\sum }_{m = 0}^{M - 1} {\sum }_{n = 0}^{N - 1} x ( m , n ) {e}^{- j 2 π ( \frac{um}{M} + \frac{vn}{N} )}$$

2D discrete Fourier transform. It should be realized that this is merely an example and the present invention is not limited thereto.

where (m, n) denotes the coordinate of an image pixel in the spatial domain; x(m, n) is the pixel value; (u, v) represents the coordinate of a spatial frequency in frequency domain; F(x)(u, v) is the complex frequency value of image x; e and j are Euler's number and the imaginary unit, respectively. Accordingly, F⁻¹(·) is the 2D inverse discrete Fourier transform which converts frequency spectrum to spatial domain. Following Euler's formula:

$${e}^{j θ} = cos ( θ ) + j sin ( θ )$$

According to the above formula, the image is decomposed into orthogonal sine and cosine functions which constitute the imaginary and real part of

$$A ( x ) ( u , v ) = {( {R}^{2} ( x ) ( u , v ) + {I}^{2} ( x ) ( u , v ) )}^{1 / 2} , 𝒫 ( x ) ( u , v ) = arctan ( \frac{I ( x ) ( u , v )}{R ( x ) ( u , v )} ) ,$$

the frequency component F(x), respectively. Then, the amplitude and phase spectra of F(x)(u, v) are defined as:
where R(x) and I(x) represent the real part and imaginary part of F(x), respectively.

Furthermore, a Gaussian kernel is used to create a soft-assignment map, denoted as G. The soft-assignment map is defined as follows:

$$G ( u , v ) = {e}^{- {D}^{2} ( u , v ) / 2 {D}_{0}^{2}} ,$$

where D₀ is a positive constant that represents the cut-off frequency, and D₀² is the distance between a point (u, v) in the frequency domain and the center of the frequency rectangle, that is,

$$D ( u , v ) = {( {( u - M / 2 )}^{2} + {( v - N / 2 )}^{2} )}^{1 / 2} ,$$

where M and N represent the height and width of the frequency rectangle and image, respectively.

According to the present embodiment, the augmented synthetic dataset is then generated by applying the following formula to two randomly sampled images x_{syn} and xᵣₑₐₗ:

$${x}_{syn}^{′} = {ℱ}^{- 1} ( ( 1 - G ) ◦ 𝒜 ( {x}_{real} ) + G ◦ 𝒜 ( {x}_{syn} ) , 𝒫 ( {x}_{syn} ) ) ,$$

where ○ denotes the element-wise multiplication operation. The low-frequency information of synthetic data is maintained and high-frequency details from the amplitude components of the real image is incorporated. The resulting amplitude components are then combined with the phase components of x_{syn} to obtain the final augmented synthetic image x′_{syn}.

In conclusion, this current embodiment employs a soft-assignment map to merge the low-frequency elements of synthetic images with the high-frequency elements of real images, generating a more authentic augmented synthetic image. Importantly, the method exclusively utilizes the amplitude spectra of real images to capture high-frequency components, with no incorporation of labels or identity information during the training phase. This unique approach allows the technique to be applied to diverse image datasets without the requirement for manual annotation or labeling, rendering it a versatile tool applicable across various computer vision applications.

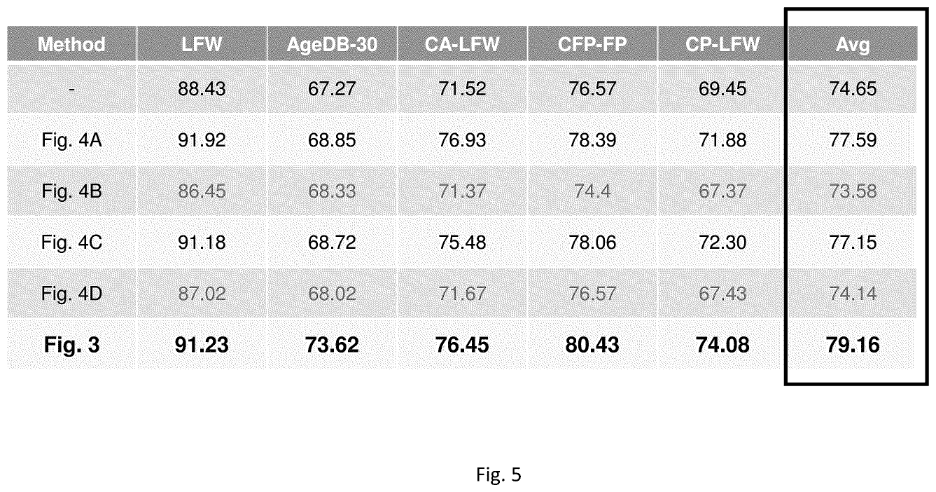

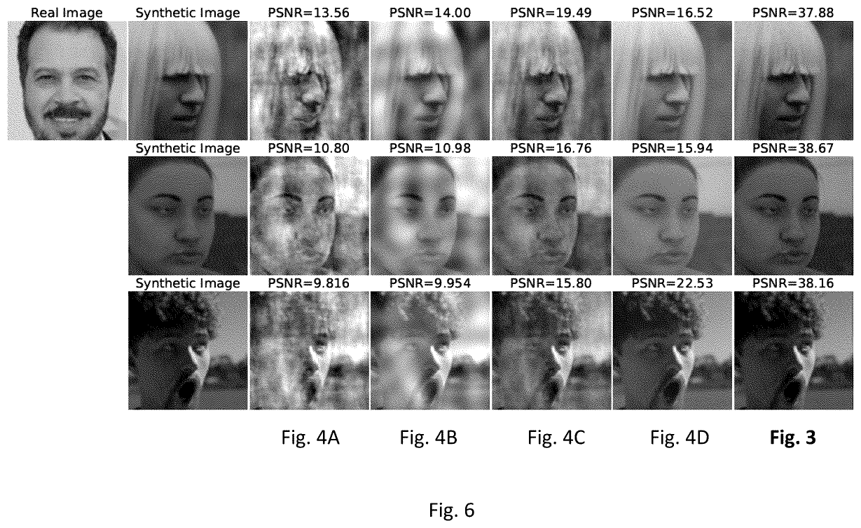

To better comprehend the efficacy of the method proposed in the present invention in comparison to alternative approaches, please refer to FIGS. 3˜6. FIG. 3 provides a conceptual overview demonstrating how an augmented synthetic dataset is generated. FIGS. 4A˜4D offer conceptual overviews illustrating various methods for generating an augmented synthetic dataset, as compared to the method illustrated in FIG. 3. FIG. 5 depict example comparison results of the performance/average accuracy using various methods illustrated in FIG. 3 and FIGS. 4A˜4D. FIG. 6 is the visualization results using various methods illustrated in FIG. 3 and FIGS. 4A˜4D and peak signal-to-noise ratio (PSNR) values indicating the image quality and similarity between original synthetic image and the augmented synthetic dataset.

In FIG. 4A, the source image's amplitude spectrum is directly substituted with that of the target image, which causes the inconsistency between the phase and amplitude of the synthetic image. FIG. 4B employs a frequency mask/square mask to swap the low-frequency components of the source amplitude spectrum, leading to a ringing effect on the augmented image as the square mask works as an ideal filter. FIG. 4C combines two amplitude spectra through a weighted sum operation, without considering that different frequencies have different importance and information, which produces artifacts in the augmented images. FIG. 4D preserves the high-frequency components of the source amplitude spectrum and merges the low-frequency components of the source with those of the target image.

Nevertheless, their configuration results in adjustments to only a limited number of frequency points on the synthetic image, leading to changes solely in image intensities within the spatial domain. Put differently, expanding the hyperparameter of these methods can induce a ringing effect, as demonstrated in the outcomes presented in FIG. 5. Additionally, the peak signal-to-noise ratio (PSNR) values for these augmented images is calculated, as depicted in FIG. 6. The findings emphasize that the methodology depicted in FIG. 3 excels in producing high-quality images that closely resemble the original synthetic images when compared to the techniques illustrated in FIGS. 4A˜4D.

The present invention introduces a novel method and system for enhancing recognition model accuracy across source and target domains through the manipulation of frequency components. By applying Fourier Transform, Gaussian filters, and soft-assignment maps, the system efficiently addresses domain gaps and preserves sensitive data while generating augmented synthetic datasets. These advancements contribute to the field of machine learning and recognition models, offering improved performance in a wide range of applications. In sum, the present invention has the following advantages: improved recognition model accuracy across source and target domains by minimizing domain gaps; enhanced privacy preservation during data processing; and flexible application of inverse Fourier transforms for dataset generation.

The system also introduces a robust face recognition system that tackles privacy concerns by utilizing a synthetic dataset. The proposed method strategically combines spatial data augmentations (SA) and Spectrum Mixup (SMU) to enhance data variation and minimize the synthetic-to-real domain gap. Firstly, a comprehensive analysis of common data augmentations under various real-world conditions and color spaces (e.g., RGB/gray-space) was undertaken to identify the optimal combination for face recognition using synthetic datasets. Secondly, the factors contributing to the domain gap between real and synthetic datasets were explored. Spectrum Mixup (SMU), a novel frequency domain mixup method, was introduced to bridge this gap and enhance recognition performance. It's crucial to note that the training stage solely utilizes synthetic data and real images (without labels), without incorporating data from the target dataset.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

What is claimed is:

1. A method for enhancing recognition model accuracy across source and target domains, comprising the steps of:
extracting amplitude and phase components from a source domain dataset and a target domain dataset, respectively;
separating high-frequency components from the amplitude components of the target domain dataset and low-frequency components from the amplitude components of the source domain dataset;
creating an augmented amplitude in a frequency domain by incorporating the high-frequency components separated from the target domain dataset into the low-frequency components separated from the source domain dataset;
generating an augmented synthetic dataset based on the augmented amplitude and the phase components of the source domain dataset; and
training the recognition model with the augmented synthetic dataset.

2. The method according to claim 1, wherein the amplitude and phase components are extracted by applying Fourier Transform to the source domain dataset and the target domain dataset.

3. The method according to claim 1, wherein frequency components of both the source domain dataset and the target domain dataset are acquired through the application of a 2D discrete Fourier Transform.

4. The method according to claim 1, wherein the high-frequency components are separated by a high-pass Gaussian filter and the low-frequency components are separated by a low-pass Gaussian filter.

5. The method according to claim 1, wherein the augmented amplitude is created by combining the low-frequency components of the source domain dataset, which have been modified using a Gaussian mask, and the high-frequency components of the target domain dataset, which have undergone a complementary operation (1-Gaussian) that subtracts each value in the Gaussian mask from 1.

6. The method according to claim 1, wherein the high-frequency components of the target domain dataset and the low-frequency components of the source domain dataset are incorporated to minimize domain gap between the source domain dataset and the target domain dataset by using a Gaussian-based soft-assignment map.

7. The method according to claim 1, wherein the phase components of the target domain dataset, which contain data requiring privacy preservation, are filtered out during the generation of the augmented synthetic dataset.

8. The method according to claim 1, wherein the augmented synthetic dataset is generated by applying an inverse discrete Fourier transform (DFT) or an inverse fast Fourier transform (FFT) to the augmented amplitude and the phase components of the source domain dataset.

9. The method according to claim 1, wherein the augmented synthetic dataset contains labels encoded in the phase components of the source domain dataset.

10. The method according to claim 1, wherein the augmented synthetic dataset undergoes desensitization before being supplied to the recognition model.

11. A system for enhancing recognition model accuracy across source and target domains, comprising:
a database, stored with a source domain dataset and a target domain dataset;
a processing unit, connected to the database, for extracting amplitude and phase components from the source domain dataset and the target domain dataset, respectively, and for separating high-frequency components from the amplitude components of the target domain dataset and low-frequency components from the amplitude components of the source domain dataset;
an integration unit, connected to the processing unit, for creating an augmented amplitude in a frequency domain by incorporating the high-frequency components separated from the target domain dataset into the low-frequency components separated from the source domain dataset;
a dataset generating unit, connected to the integration unit, for generating an augmented synthetic dataset based on the augmented amplitude and the phase components of the source domain dataset; and
a recognition model, connected to the dataset generating unit, trained with the augmented synthetic dataset provided by the dataset generating unit.

12. The system according to claim 11, wherein the amplitude and phase components are extracted by applying Fourier Transform to the source domain dataset and the target domain dataset.

13. The system according to claim 11, wherein frequency components of both the source domain dataset and the target domain dataset are acquired through the application of a 2D discrete Fourier Transform.

14. The system according to claim 11, wherein the high-frequency components are separated by a high-pass Gaussian filter and the low-frequency components are separated by a low-pass Gaussian filter.

15. The system according to claim 11, wherein the augmented amplitude is created by combining the low-frequency components of the source domain dataset, which have been modified using a Gaussian mask, and the high-frequency components of the target domain dataset, which have undergone a complementary operation (1-Gaussian) that subtracts each value in the Gaussian mask from 1.

16. The system according to claim 11, wherein the high-frequency components of the target domain dataset and the low-frequency components of the source domain dataset are incorporated to minimize domain gap between the source domain dataset and the target domain dataset by using a Gaussian-based soft-assignment map.

17. The system according to claim 11, wherein the phase components of the target domain dataset, which contain data requiring privacy preservation, are filtered out during the generation of the augmented synthetic dataset.

18. The system according to claim 11, wherein the augmented synthetic dataset is generated by applying an inverse discrete Fourier transform (DFT) or an inverse fast Fourier transform (FFT) to the augmented amplitude and the phase components of the source domain dataset.

19. The system according to claim 11, wherein the augmented synthetic dataset contains labels encoded in the phase components of the source domain dataset.

20. The system according to claim 11, wherein the augmented synthetic dataset undergoes desensitization before being supplied to the recognition model.
